(19) United States
(12) Patent Application Publication
(10) Pub. No.: US 2019/0281273 A1
(43) Pub. Date: Sep. 12, 2019

(54) ADAPTIVE LOOP FILTERING METHOD FOR RECONSTRUCTED PROJECTION-BASED FRAME THAT EMPLOYS PROJECTION LAYOUT OF 360-DEGREE VIRTUAL REALITY PROJECTION

(71) Applicant: MEDIATEK INC., Hsin-Chu (TW)

(72) Inventors: Sheng-Yen Lin, Hsin-Chu (TW); Jian-Liang Lin, Hsin-Chu (TW)

(21) Appl. No.: 16/296,187

(22) Filed: Mar. 7, 2019

Related U.S. Application Data
(60) Provisional application No. 62/640,072, filed on Mar. 8, 2018.

(51) Int. Cl. H04N 13/161; H04N 19/117; H04N 19/82; H04N 19/167; H04N 19/176; H04N 19/597

(52) U.S. Cl. CPC H04N 13/161; H04N 19/117; H04N 19/597; H04N 19/167; H04N 19/176; H04N 19/82

(57) ABSTRACT

An adaptive loop filtering (ALF) method for a reconstructed projection-based frame includes: obtaining at least one spherical neighboring pixel in a padding area that acts as an extension of a face boundary of a first projection face, and applying adaptive loop filtering to a block in the first projection face. In the reconstructed projection-based frame, there is image content discontinuity between the face boundary of the first projection face and a face boundary of a second projection face. A region on the sphere to which the padding area corresponds is adjacent to a region on the sphere from which the first projection face is obtained. The at least one spherical neighboring pixel is involved in the adaptive loop filtering of the block.

### CROSS REFERENCE TO RELATED APPLICATIONS

This application claims the benefit of U.S. provisional application No. 62/640,072, filed on Mar. 8, 2018 and incorporated herein by reference.

### BACKGROUND

The present invention relates to processing omnidirectional video content, and more particularly, to an adaptive loop filtering (ALF) method for a reconstructed projection-based frame that employs a projection layout of a 360-degree virtual reality (360 VR) projection.

Virtual reality (VR) with head-mounted displays (HMDs) is associated with a variety of applications. The ability to show wide field of view content to a user can be used to provide immersive visual experiences. A real-world environment has to be captured in all directions resulting in an omnidirectional image content corresponding to a sphere. With advances in camera rigs and HMDs, the delivery of VR content may soon become the bottleneck due to the high bitrate required for representing such a 360-degree image content. When the resolution of the omnidirectional video is 4K or higher, data compression/encoding is critical to bitrate reduction.

Data compression/encoding of the omnidirectional video may be achieved by a conventional video coding standard that generally adopt a block-based coding technique to exploit spatial and temporal redundancy. For example, the basic approach is to divide a source frame into a plurality of blocks (or coding units), perform intra prediction/inter prediction on each block, transform residues of each block, and perform quantization and entropy encoding. Besides, a reconstructed frame is generated to provide reference pixel data used for coding following blocks. For certain video coding standards, in-loop filter(s) may be used for enhancing the image quality of the reconstructed frame. For example, an adaptive loop filter is used by a video encoder to minimize the mean square error between the reconstructed frame and the original frame by using Wiener-based adaptive filter. The adaptive loop filter may be regarded as a tool to catch and fix artifacts in the reconstructed frame. A video decoder is used to perform an inverse operation of a video encoding operation performed by the video encoder. Hence, the video decoder also has in-loop filter(s) used for enhancing the image quality of the reconstructed frame. For example, an adaptive loop filter is also used by the video decoder to reduce the artifacts.

In general, the omnidirectional video content corresponding to the sphere is transformed into a sequence of images, each of which is a projection-based frame with a 360-degree image content represented by one or more projection faces arranged in a 360-degree Virtual Reality (360 VR) projection layout, and then the sequence of the projection-based frames is encoded into a bitstream for transmission. However, the projection-based frame may have image content discontinuity at picture boundaries (i.e., layout boundaries) and/or face edges (i.e., face boundaries). Hence, there is a need for an innovative adaptive loop filter design that is capable of performing a more accurate adaptive loop filtering process on any pixel near one discontinuous picture boundary, and/or dealing with an adaptive loop filtering process of any pixel near one discontinuous face edge correctly.

### SUMMARY

One of the objectives of the claimed invention is to provide an adaptive loop filtering (ALF) method for a reconstructed projection-based frame that employs a projection layout of a 360-degree virtual reality (360 VR) projection. For example, a spherical neighbor based ALF method is employed by an adaptive loop filter. In this way, an adaptive loop filtering process of a pixel near a discontinuous picture boundary can be more accurate, and/or an adaptive loop filtering process of a pixel near a discontinuous face edge can work correctly.

According to a first aspect of the present invention, an exemplary adaptive loop filtering (ALF) method for a reconstructed projection-based frame is disclosed. The reconstructed projection-based frame comprises a plurality of projection faces packed in a projection layout of a 360-degree Virtual Reality (360 VR) projection from which a 360-degree image content of a sphere is mapped onto the projection faces. The exemplary ALF method includes: obtaining, by an adaptive loop filter, at least one spherical neighboring pixel in a padding area that acts as an extension of a face boundary of a first projection face, and applying adaptive loop filtering to a block in the first projection face. The projection faces packed in the reconstructed projection-based frame comprise the first projection face and a second projection face. In the reconstructed projection-based frame, the face boundary of the first projection face connects with a face boundary of the second projection face, and there is image content discontinuity between the face boundary of the first projection face and the face boundary of the second projection face. A region on the sphere to which the padding area corresponds is adjacent to a region on the sphere from which the first projection face is obtained. The at least one spherical neighboring pixel is involved in the adaptive loop filtering of the block.

According to a second aspect of the present invention, an exemplary adaptive loop filtering (ALF) method for a reconstructed projection-based frame is disclosed. The reconstructed projection-based frame comprises at least one projection face packed in a projection layout of a 360-degree Virtual Reality (360 VR) projection from which a 360-degree image content of a sphere is mapped onto the at least one projection face. The exemplary ALF method includes: obtaining, by an adaptive loop filter, at least one spherical neighboring pixel in a padding area that acts as an extension of one face boundary of a projection face packed in the reconstructed projection-based frame, and applying adaptive loop filtering to a block in the projection face. The face boundary of the projection face is a part of a picture boundary of the reconstructed projection-based frame. A region on the sphere to which the padding area corresponds is adjacent to a region on the sphere from which the projection face is obtained. The at least one spherical neighboring pixel is involved in the adaptive loop filtering of the block.

According to a third aspect of the present invention, an exemplary adaptive loop filtering (ALF) method for a reconstructed projection-based frame is disclosed. The reconstructed projection-based frame comprises a plurality of projection faces packed in a projection layout of a 360-degree Virtual Reality (360 VR) projection from which a 360-degree image content of a sphere is mapped onto the projection faces. The exemplary ALF method includes: obtaining, by an adaptive loop filter, at least one spherical neighboring pixel in a padding area that acts as an extension of one face boundary of a first projection face, and applying adaptive loop filtering to a block in the first projection face. The projection faces packed in the reconstructed projection-based frame comprise the first projection face and a second projection face. In the reconstructed projection-based frame, the face boundary of the first projection face connects with a face boundary of the second projection face. There is image content continuity between the face boundary of the first projection face and the face boundary of the second projection face. A region on the sphere to which the padding area corresponds is adjacent to a region on the sphere from which the first projection face is obtained. The at least one spherical neighboring pixel is involved in the adaptive loop filtering of the block.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a 360-degree Virtual Reality (360 VR) system according to an embodiment of the present invention.

FIG. 2 is a diagram illustrating a cube-based projection according to an embodiment of the present invention.

FIG. 3 is a flowchart illustrating a luma component processing flow of a spherical neighbor based adaptive loop filtering method according to an embodiment of the present invention.

FIG. 4 is a diagram illustrating a pixel that is classified by using histogram pixel-level adaptation.

FIG. 5 is a diagram illustrating one 2×2 block that is classified by using 2×2 block-level adaptation.

FIG. 6 is a diagram illustrating one selected filter used by a filter process.

FIG. 7 is a flowchart illustrating a chroma component processing flow of the spherical neighbor based adaptive loop filtering method according to an embodiment of the present invention.

FIG. 8 is a diagram illustrating one arrangement of reconstructed frame data and padding pixel data stored in working buffers of adaptive loop filter according to an embodiment of the present invention.

FIG. 9 is a diagram illustrating image content continuity relations among square projection faces packed in a compact cubemap projection layout shown in FIG. 2.

FIG. 10 is a diagram illustrating a spherical neighboring pixel found by a geometry based scheme according to an embodiment of the present invention.

FIG. 11 is a diagram illustrating an example of generating an interpolated pixel value for a point according to an embodiment of the present invention.

FIG. 12 is a diagram illustrating process units determined and used by adaptive loop filter according to an embodiment of the present invention.

FIG. 13 is a diagram illustrating another arrangement of reconstructed frame data and padding pixel data stored in working buffers of adaptive loop filter according to an embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

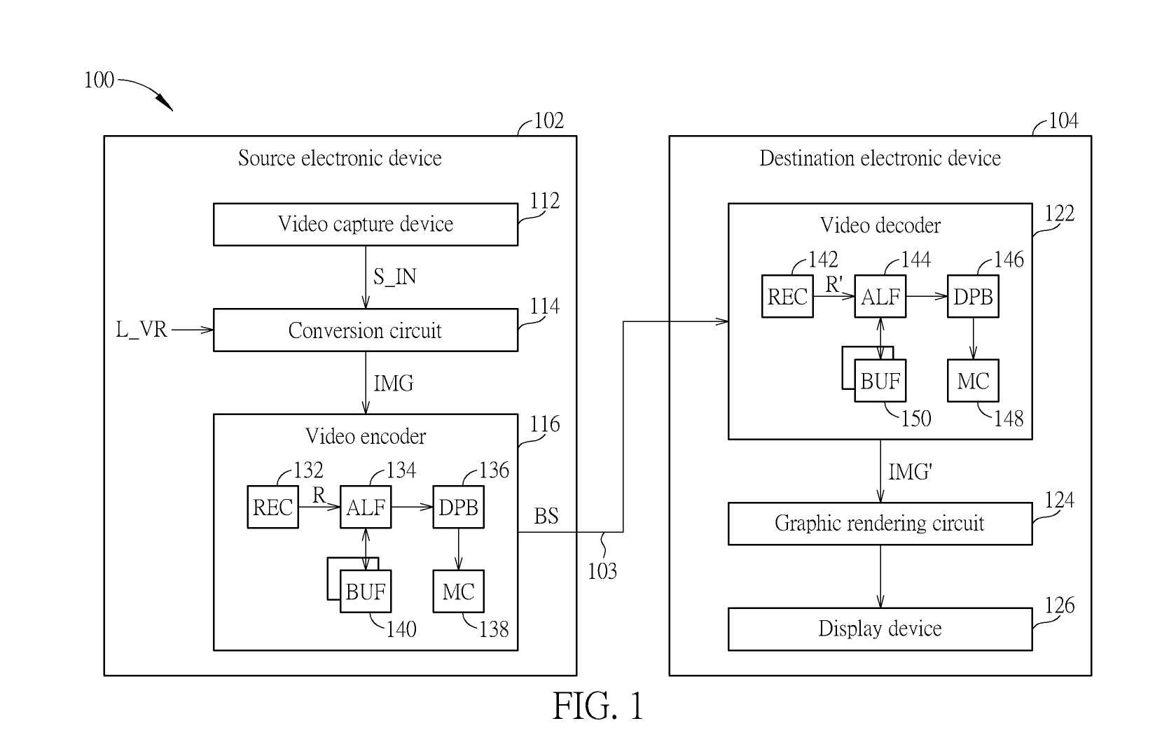

FIG. 1 is a diagram illustrating a 360-degree Virtual Reality (360 VR) system according to an embodiment of the present invention. The 360 VR system 100 includes two video processing apparatuses (e.g., a source electronic device 102 and a destination electronic device 104). The source electronic device 102 includes a video capture device 112, a conversion circuit 114, and a video encoder 116. For example, the video capture device 112 may be a set of cameras used to provide an omnidirectional image content (e.g., multiple images that cover the whole surroundings) S_IN corresponding to a sphere. The conversion circuit 114 is coupled between the video capture device 112 and the video encoder 116. The conversion circuit 114 generates a projection-based frame IMG with a 360-degree Virtual Reality (360 VR) projection layout L_VR according to the omnidirectional image content S_IN. For example, the projection-based frame IMG may be one frame included in a sequence of projection-based frames generated from the conversion circuit 114. The video encoder 116 is an encoding circuit used to encode/compress the projection-based frame IMG to generate a part of a bitstream BS. Further, the video encoder 116 outputs the bitstream BS to the destination electronic device 104 via a transmission means 103. For example, the sequence of projection-based frames may be encoded into the bitstream BS, and the transmission means 103 may be a wired/wireless communication link or a storage medium.

The destination electronic device 104 may be a head-mounted display (HMD) device. As shown in FIG. 1, the destination electronic device 104 includes a video decoder 122, a graphic rendering circuit 124, and a display device 126. The video decoder 122 is a decoding circuit used to receive the bitstream BS from the transmission means 103 (e.g., wired/wireless communication link or storage medium), and decode a part of the received bitstream BS to generate a decoded frame IMG′. For example, the video decoder 122 generates a sequence of decoded frames by decoding the received bitstream BS, where the decoded frame IMG′ is one frame included in the sequence of decoded frames. In this embodiment, the projection-based frame IMG to be encoded by the video encoder 116 has the 360 VR projection layout L_VR. Hence, after a part of the bitstream BS is decoded by the video decoder 122, the decoded frame IMG′ is a decoded projection-based frame having the same 360 VR projection layout L_VR. The graphic rendering circuit 124 is coupled between the video decoder 122 and the display device 126. The graphic rendering circuit 124 renders and displays an output image data on the display device 126 according to the decoded frame IMG′. For example, a viewport area associated with a portion of the 360-degree image content carried by the decoded frame IMG′ may be displayed on the display device 126 via the graphic rendering circuit 124.

The video encoder 116 may employ a block-based coding scheme for encoding the projection-based frame IMG. Hence, the video encoder 116 has an adaptive loop filter (denoted by “ALF”) 134 to catch and fix artifacts which appear after block-based coding. Specifically, a reconstructed projection-based frame R generated from a reconstruction circuit (denoted by “REC”) 132 can be used as a reference frame for coding following blocks, and is stored into a reference frame buffer (denoted by “DPB”) 136 through the adaptive loop filter 134. For example, a motion compensation circuit (denoted by “MC”) 138 can use a block found in the reference frame to act as a predicted block. In addition, at least one working buffer (denoted by “BUF”) 140 can be used to store reconstructed frame data and/or padding pixel data required by an adaptive loop filtering process performed at the adaptive loop filter 134.

The adaptive loop filter 134 may be a block-based adaptive loop filter, and the adaptive loop filtering process may use one block as a basic processing unit. For example, a processing unit may be one coding tree block (CTB) or may be a partition of one CTB. The adaptive loop filtering process is performed on reconstructed frame data and/or padding pixel data stored in the working buffer(s) 140. The reconstructed frame data stored in the working buffer(s) 140 remain unchanged during the adaptive loop filtering process. In other words, filtered pixel values of pixels generated by the adaptive loop filtering process are not written into the working buffer(s) 140. Instead, filtered pixel values of pixels generated by the adaptive loop filtering process are written into the reconstructed projection-based frame R to update/overwrite original pixel values of the pixels in the reconstructed projection-based frame R. Since the reconstructed frame data stored in the working buffer(s) 140 remain unchanged during the adaptive loop filtering process, a filtering process of a current pixel is not affected by filtering results of previous pixels.

The reconstructed projection-based frame R is generated by an internal decoding loop of the video encoder 116. In other words, the reconstructed projection-based frame R is reconstructed from encoded data of the projection-based frame IMG, and thus has the same 360 VR projection layout L_VR used by the projection-based frame IMG. It should be noted that the video encoder 116 may include other circuit blocks (not shown) required to achieve the designated encoding function.

The video decoder 122 is used to perform an inverse operation of a video encoding operation performed by the video encoder 116. Hence, the video decoder 122 has an adaptive loop filter (denoted by “ALF”) 144 to reduce the artifacts. Specifically, a reconstructed projection-based frame R′ generated from a reconstruction circuit (denoted by “REC”) 142 can be used as a reference frame for decoding following blocks, and is stored into a reference frame buffer (denoted by “DPB”) 146 through the adaptive loop filter 144. For example, a motion compensation circuit (denoted by “MC”) 148 can use a block found in the reference frame to act as a predicted block. In addition, at least one working buffer (denoted by “BUF”) 150 can be used to store reconstructed frame data and/or padding pixel data required by an adaptive loop filtering process performed at the adaptive loop filter 144.

The adaptive loop filter 144 may be a block-based adaptive loop filter, and the adaptive loop filtering process may use a block as a basic processing unit. For example, a processing unit may be one coding tree block (CTB) or may be a partition of one CTB. The adaptive loop filtering process is performed on reconstructed frame data and/or padding pixel data stored in the working buffer(s) 150. The reconstructed frame data stored in the working buffer(s) 150 remain unchanged during the adaptive loop filtering process. In other words, filtered pixel values of pixels generated by the adaptive loop filtering process are not written into the working buffer(s) 150. Instead, filtered pixel values of pixels generated by the adaptive loop filtering process are written into the reconstructed projection-based frame R′ to update/overwrite original pixel values of the pixels in the reconstructed projection-based frame R′. Since the reconstructed frame data stored in the working buffer(s) 150 remain unchanged during the adaptive loop filtering process, a filtering process of a current pixel is not affected by filtering results of previous pixels.

The reconstructed projection-based frame R′ is reconstructed from encoded data of the projection-based frame IMG, and thus has the same 360 VR projection layout L_VR used by the projection-based frame IMG. In addition, the decoded frame IMG′ may be generated by passing the reconstructed projection-based frame R′ through the adaptive loop filter 144. It should be noted that the video decoder 122 may include other circuit blocks (not shown) required to achieve the designated decoding function.

In one exemplary design, the adaptive loop filter 134/144 may be implemented by dedicated hardware used to perform an adaptive loop filtering process upon a block. In another exemplary design, the adaptive loop filter 134/144 may be implemented by a general purpose processor that executes a program code to perform an adaptive loop filtering process upon a block. However, these are for illustrative purposes only, and are not meant to be limitations of the present invention.

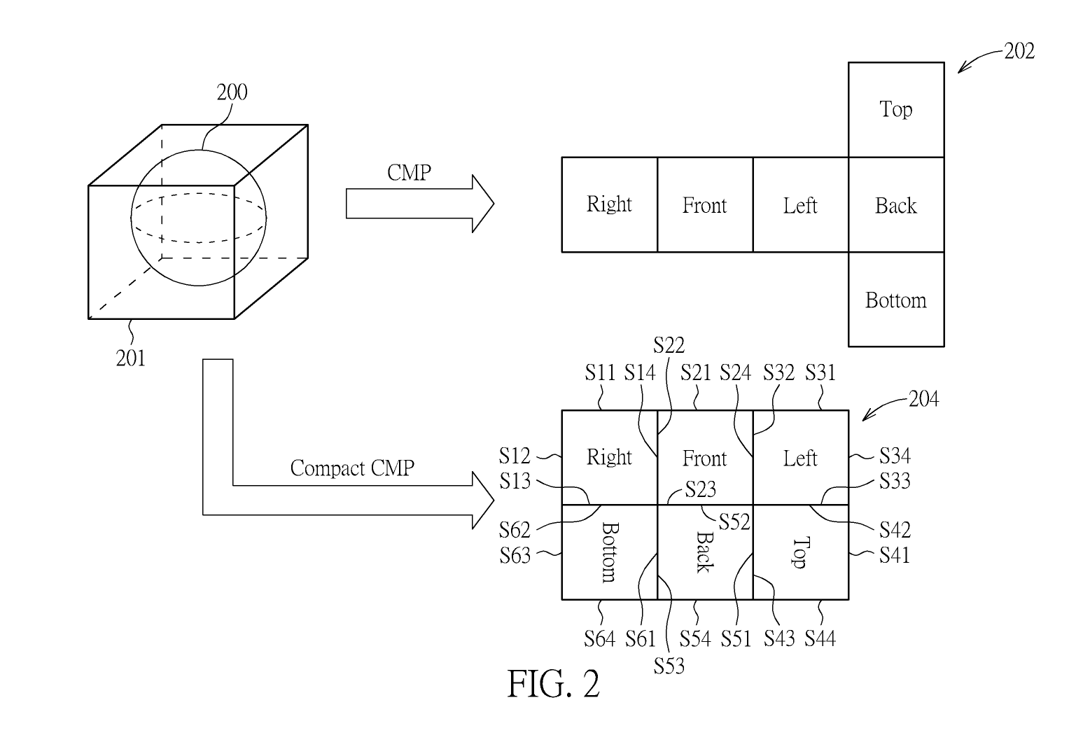

As mentioned above, the conversion circuit 114 generates the projection-based frame IMG according to the 360 VR projection layout L_VR and the omnidirectional image content S_IN. In a case where the 360 VR projection layout L_VR is a cube-based projection layout, six square projection faces are derived from different faces of a cube through a cube-based projection of the omnidirectional image content S_IN on a sphere. FIG. 2 is a diagram illustrating a cube-based projection according to an embodiment of the present invention. The 360-degree image content on a sphere 200 is projected onto six faces of a cube 201, including a top face, a bottom face, a left face, a front face, a right face, and a back face. Specifically, an image content of a north polar region of the sphere 200 is projected onto the top face of the cube 201, an image content of a south polar region of the sphere 200 is projected onto the bottom face of the cube 201, and an image content of an equatorial region of the sphere 200 is projected onto the left face, the front face, the right face, and the back face of the cube 201.

Square projection faces to be packed in a projection layout of the cube-based projection are derived from six faces of the cube 201, respectively. For example, a square projection face (labeled by “Top”) on a two-dimensional (2D) plane is derived from the top face of the cube 201 in a three-dimensional (3D) space, a square projection face (labeled by “Back”) on the 2D plane is derived from the back face of the cube 201 in the 3D space, a square projection face (labeled by “Bottom”) on the 2D plane is derived from the bottom face of the cube 201 in the 3D space, a square projection face (labeled by “Right”) on the 2D plane is derived from the right face of the cube 201 in the 3D space, a square projection face (labeled by “Front”) on the 2D plane is derived from the front face of the cube 201 in the 3D space, and a square projection face (labeled by “Left”) on the 2D plane is derived from the left face of the cube 201 in the 3D space.

When the 360 VR projection layout L_VR is set by a cubemap projection (CMP) layout 202 shown in FIG. 2, the square projection faces “Top”, “Back”, “Bottom”, “Right”, “Front”, and “Back” are packed in the CMP layout 202 corresponding to an unfolded cube. However, the projection-based frame IMG to be encoded is required to be rectangular. If the CMP layout 202 is directly used for creating the projection-based frame IMG, the projection-based frame IMG has to be filled with dummy areas (e.g., black areas, gray areas, or white areas) to form a rectangular frame for encoding. Alternatively, the projection-based frame IMG can have projected image data arranged in a compact projection layout to avoid using dummy areas (e.g., black areas, gray areas, or white areas). As shown in FIG. 2, the square projection faces “Top”, “Back” and “Bottom” are rotated and then packed in the compact CMP layout 204. Hence, the square projection faces “Top”, “Back”, “Bottom”, “Right”, “Front”, and “Back” are arranged in the compact CMP layout 204 that is a 3×2 layout. In this way, the coding efficiency can be improved.

However, in accordance with the compact CMP layout 204, it is possible that packing of square projection faces may result in image content discontinuity edges between adjacent square projection faces. As shown in FIG. 2, the projection-based frame IMG with the compact CMP layout 204 has a top sub-frame (which is one 3×1 face row consisting of square projection faces “Right”, “Front” and “Left”) and a bottom sub-frame (which is the other 3×1 face row consisting of square projection faces “Bottom”, “Back” and “Top”). There is an image content discontinuity edge between the top sub-frame and the bottom sub-frame. Specifically, the face boundary S13 of the square projection face “Right” connects with the face boundary S62 of the square projection face “Bottom”, the face boundary S23 of the square projection face “Front” connects with the face boundary S52 of the square projection face “Back”, and the face boundary S33 of the square projection face “Left” connects with the face boundary S42 of the square projection face “Top”, where there is image content discontinuity between face boundaries S13 and S62, there is image content discontinuity between face boundaries S23 and S52, and there is image content discontinuity between face boundaries S33 and S42.

Further, in accordance with the compact CMP layout 204, it is possible that packing of square projection faces may result in image content continuity edges between adjacent square projection faces. Regarding the top sub-frame, the face boundary S14 of the square projection face “Right” connects with the face boundary S22 of the square projection face “Front”, and the face boundary S24 of the square projection face “Front” connects with the face boundary S32 of the square projection face “Left”, where there is image content continuity between face boundaries S14 and S22, and there is image content continuity between face boundaries S24 and S32. Regarding the bottom sub-frame, the face boundary S61 of the square projection face “Bottom” connects with the face boundary S53 of the square projection face “Back”, and the face boundary S51 of the square projection face “Back” connects with the face boundary S43 of the square projection face “Top”, where there is image content continuity between face boundaries S61 and S53, and there is image content continuity between face boundaries S51 and S43.

Moreover, the compact CMP layout 204 has a top discontinuous boundary (which consists of face boundaries S11, S21, S31 of square projection faces “Right”, “Front” and “Left”), a bottom discontinuous boundary (which consists of face boundaries S64, S54, S44 of square projection faces “Bottom”, “Back” and “Top”), a left discontinuous boundary (which consists of face boundaries S12, S63 of square projection faces “Right” and “Bottom”), and a right discontinuous boundary (which consists of face boundaries S34, S41 of square projection faces “Left” and “Top”).

An image content discontinuity edge between the top sub-frame and the bottom sub-frame of the reconstructed projection-based frame R/R′ with the compact CMP layout 204 is caused by face packing rather than blocked-based coding. In accordance with the compact CMP layout 204, the image content discontinuity edge between the top sub-frame and the bottom sub-frame includes an image content discontinuity edge between projection faces “Right” and “Bottom”, an image content discontinuity edge between projection faces “Front” and “Back”, and an image content discontinuity edge between projection faces “Left” and “Top”. The picture quality of the reconstructed projection-based frame R/R′ will be degraded by a typical adaptive loop filter that applies a typical adaptive loop filtering process to pixels near the image content discontinuity edge between the top sub-frame and the bottom sub-frame of the reconstructed projection-based frame R/R′. In addition, when applying the typical adaptive loop filtering process to pixels near the picture boundaries, the typical adaptive loop filter uses padding pixels generated from directly repeating the boundary pixels. However, the padding pixels are not real neighboring pixels of the pixels near the picture boundaries. As a result, adaptive loop filtering of pixels near the picture boundaries is less accurate.

To address these issues, the present invention proposes an innovative spherical neighbor based adaptive loop filtering method that can be implemented in the encoder-side adaptive loop filter 134 and the decoder-side adaptive loop filter 144. When the reconstructed projection-based frame R/R′ employs the compact CMP layout 204, the adaptive loop filter 134/144 can find spherical neighboring pixels to act as padding pixels for properly dealing with adaptive loop filtering of pixels near a discontinuous picture boundary (e.g., S11, S21, S31, S12, S63, S64, S54, S44, S34, or S41 shown in FIG. 2) and/or a discontinuous face edge (e.g., S13, S23, S33, S62, S52, or S42 shown in FIG. 2). Further details of the proposed spherical neighbor based adaptive loop filtering method are described below with reference to the accompanying drawings.

In some embodiments of the present invention, the video encoder 116 may be configured to have two working buffers 140 that act as sub-frame buffers, where one sub-frame buffer is used to store a top sub-frame of the reconstructed projection-based frame R with the compact CMP layout 204 and padding areas extended from sub-frame boundaries of the top sub-frame, and the other sub-frame buffer is used to store a bottom sub-frame of the reconstructed projection-based frame R with the compact CMP layout 204 and padding areas extended from sub-frame boundaries of the bottom sub-frame. Similarly, the video decoder 122 may be configured to have two working buffers 150 that act as sub-frame buffers, where one sub-frame buffer is used to store a top sub-frame of the reconstructed projection-based frame R′ with the compact CMP layout 204 and padding areas extended from sub-frame boundaries of the top sub-frame, and the other sub-frame buffer is used to store a bottom sub-frame of the reconstructed projection-based frame R′ with the compact CMP layout 204 and padding areas extended from sub-frame boundaries of the bottom sub-frame. The adaptive loop filter 134/144 finds spherical neighboring pixels to act as padding pixels included in padding areas that surround the top sub-frame and the bottom sub-frame, and performs an adaptive loop filtering process according to reconstructed frame data and padding pixel data stored in the sub-frame buffers.

The most common way of using pixel values to represent color and brightness in full color video coding is through what it is known as YUV (YCbCr) color space. YUV color space divides a pixel value of a pixel into three channels, where the luma component (Y) represents the gray level intensity, and the chroma components (Cb, Cr) represent the extent to which the color differs from gray to blue and red, respectively. A luma component processing flow employed by the adaptive loop filter 134/144 may be different from a chroma component processing flow employed by the adaptive loop filter 134/144.

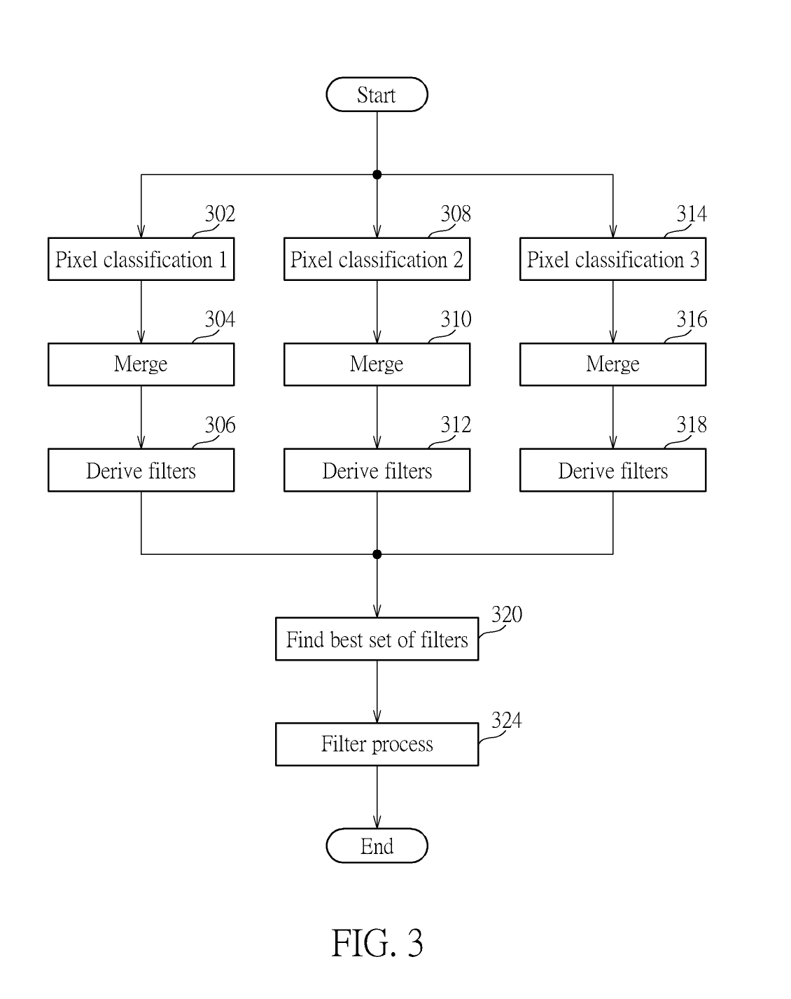

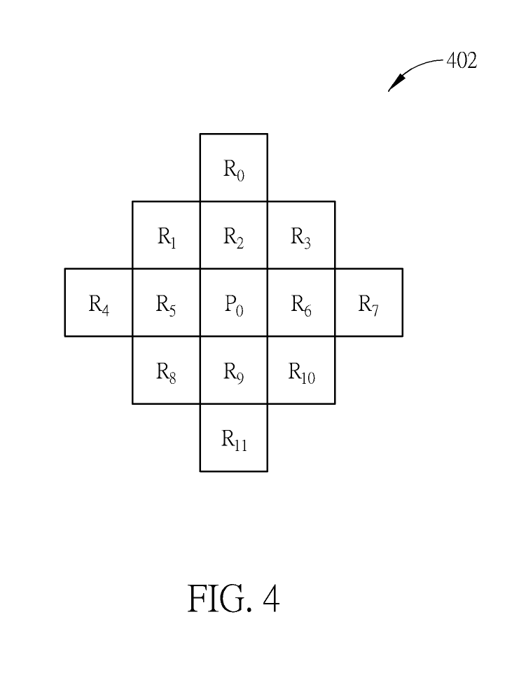

FIG. 3 is a flowchart illustrating a luma component processing flow of a spherical neighbor based adaptive loop filtering method according to an embodiment of the present invention. For luma components, three pixel classification methods are first performed at steps 302, 308, and 314. In one pixel classification method, pixels are classified into 32 groups according to pixel texture characteristics and pixel locations. At step 302, the first pixel classification method may employ intensity pixel-level adaptation. Hence, each pixel is classified into one of 32 groups defined by the first pixel classification method on the basis of its luminance value. At step 308, the second pixel classification method may employ histogram pixel-level adaptation. FIG. 4 is a diagram illustrating a pixel that is classified by using histogram pixel-level adaptation. A pixel classification filter 402 is used for classifying a target pixel P₀ into one of 32 groups defined by the second pixel classification method. The target pixel P₀ may be classified by calculating the similarity in one 5×5 diamond shape, where neighboring pixels R₀-R₁₁ are required by classification of the target pixel P₀. In accordance with the spherical neighbor based adaptive loop filtering method, one or more of the neighboring pixels R₀-R₁₁ may be padding pixels that are spherical neighboring pixels.

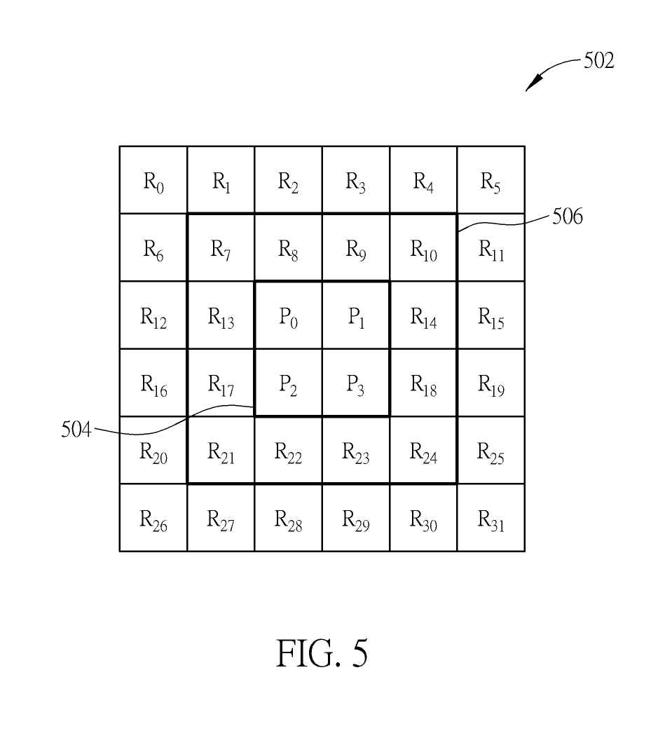

At step 314, the third pixel classification method may employ 2×2 block-level adaptation. FIG. 5 is a diagram illustrating one 2×2 block that is classified by using 2×2 block-level adaptation. A pixel classification filter 502 is used for classifying a target 2×2 block 504 (which includes four pixels P₀-P₃) into one of 32 groups defined by the third pixel classification method. For one 2×2 block 504, one 4×4 window 506 (which includes neighboring pixels R₇-R₁₀, R₁₃, R₁₄, R₁₇, R₁₈, R₂₁-R₂₄) is used to calculate the group index. For each pixel in the 4×4 window 506, the absolute values of filtered results are calculated by using [−1, 2, −1] in four directions, including {0, 45, 90, 135}. Hence, additional neighboring pixels R₀-R₅, R₆, R₁₁, R₁₂, R₁₅, R₁₆, R₁₉, R₂₀, R₂₅-R₃₁ are required by classification of the target 2×2 block 504. In accordance with the spherical neighbor based adaptive loop filtering method, one or more of the neighboring pixels R₀-R₃₁ may be padding pixels that are spherical neighboring pixels.

For each classification group, one filter (i.e., one set of filter coefficients) can be derived by solving the Wiener-Hopf equation. Therefore, 32 filters can be derived for one pixel classification method. In order to perform the same filter process at the video decoder 122, the parameters of multiple filters are encoded by the video encoder 116 and transmitted to the video decoder 122. To reduce the consumption of coding bits, a merge process is performed to reduce the number of filters for one pixel classification method.

At step 304, a merge process is conducted on classification groups of the first pixel classification method, where 32 classification groups are merged into 16 groups based on rate-distortion optimization (RDO). At step 310, a merge process is conducted on classification groups of the second pixel classification method, where 32 classification groups are merged into 16 groups based on RDO. At step 316, a merge process is conducted on classification groups of the third pixel classification method, where 32 classification groups are merged into 16 groups based on RDO. Hence, after the merge process is done, 16 filters can be derived for one pixel classification method by solving the Wiener-Hopf equation (steps 306, 312, and 318).

At step 320, the best set of filters (16 filters) is selected among three pixel classification methods based on RDO. The parameters of 16 selected filters would be encoded by the video encoder 116 and transmitted to the video decoder 122.

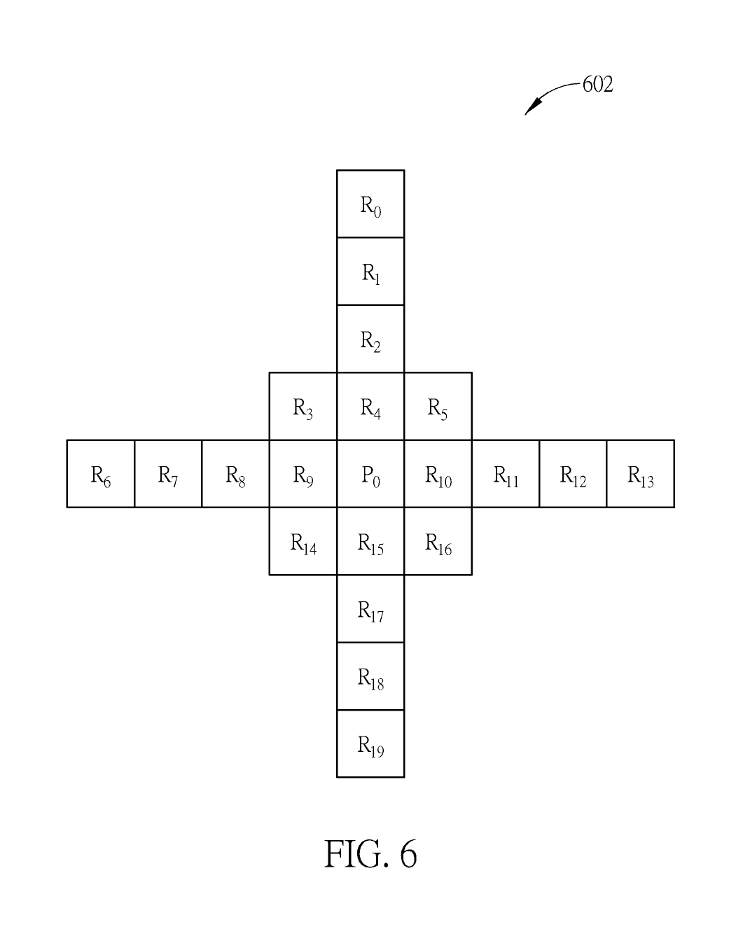

At step 324, a filter process is performed for actually applying filtering to each pixel in one block according to corresponding filter coefficients, and writing a filtered result of each pixel into the reconstructed projection-based frame R/R′ to update/overwrite an original luma component of the pixel in the reconstructed projection-based frame R/R′. FIG. 6 is a diagram illustrating one selected filter used by a filter process. The filter 602 is used to calculate a filtered result of a target pixel P₀ by applying 21 filter coefficients C₀-C₂₀ (which are found at step 320) to 21 pixels, including target pixel P₀ and its neighboring pixels R₀-R₁₉, respectively. In accordance with the spherical neighbor based adaptive loop filtering method, one or more of the neighboring pixels R₀-R₁₉ may be padding pixels that are spherical neighboring pixels.

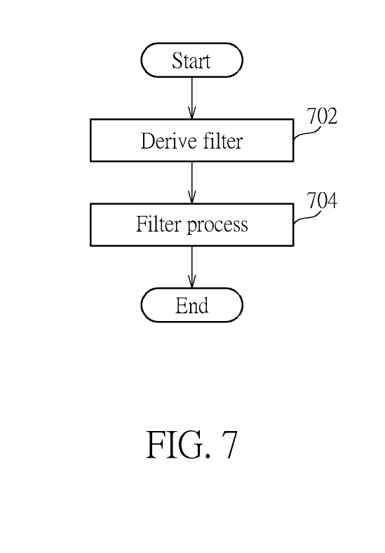

FIG. 7 is a flowchart illustrating a chroma component processing flow of the spherical neighbor based adaptive loop filtering method according to an embodiment of the present invention. The pixel classification process is only performed for the luma component (Y). As for the chroma components (Cb, Cr), a single filter (i.e., a single set of filter coefficients) is derived from all pixels in one block by solving the Wiener-Hopt equation (step 702). At step 704, a filter process is performed for actually applying filtering to each pixel in one block according to the same filter coefficients (i.e., all pixels are filtered with the same filter), and writing a filtered result of each pixel into the reconstructed projection-based frame R/R′ to update/overwrite original chroma components (Cb, Cr) of the pixel in the reconstructed projection-based frame R/R′. For example, the same filter 602 shown in FIG. 6 may also be used by the filter process of chroma components (Cb, Cr). In accordance with the spherical neighbor based adaptive loop filtering method, one or more of the neighboring pixels R₀-R₁₉ may be padding pixels that are spherical neighboring pixels.

As mentioned above, two working buffers (e.g., working buffers 140 at the encoder side or working buffers 150 at the decoder side) can be used to act as sub-frame buffers, where one sub-frame buffer is used to store a top sub-frame of the reconstructed projection-based frame R/R′ with the compact CMP layout 204 and padding areas extended from sub-frame boundaries of the top sub-frame, and the other sub-frame buffer is used to store a bottom sub-frame of the reconstructed projection-based frame R/R′ with the compact CMP layout 204 and padding areas extended from sub-frame boundaries of the bottom sub-frame. Hence, either of pixel classification (steps 302, 308, and 314) and filter process (steps 324 and 704) can read required padding pixel(s) from the sub-frame buffers.

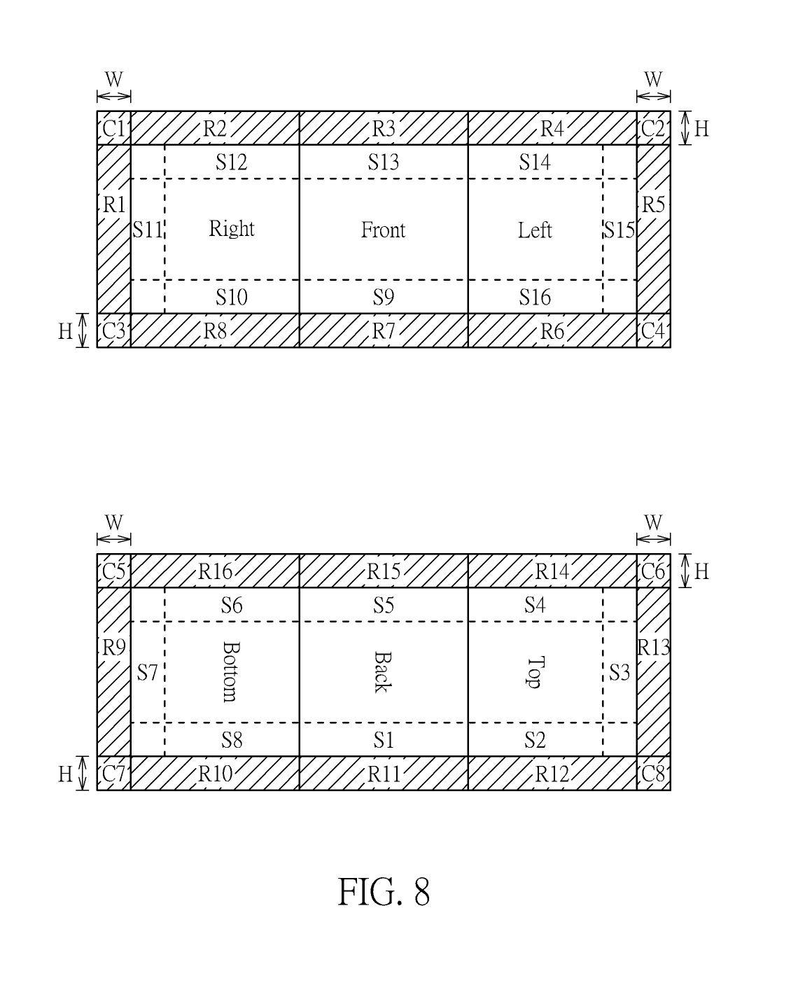

FIG. 8 is a diagram illustrating one arrangement of reconstructed frame data and padding pixel data stored in working buffers 140/150 of adaptive loop filter 134/144 according to an embodiment of the present invention. Suppose that the reconstructed projection-based frame R/R′ employs the compact CMP layout 204. Hence, the top sub-frame includes the square projection faces “Right”, “Front”, and “Left”, and the bottom sub-frame includes the square projection faces “Top”, “Back”, and “Bottom”. As mentioned above, there is an image content discontinuity edge between a bottom sub-frame boundary of the top sub-frame and a top sub-frame boundary of the bottom sub-frame. In addition, the reconstructed projection-based frame R/R′ has discontinuous picture boundaries, where a top picture boundary is also a top sub-frame boundary of the top sub-frame, a bottom picture boundary is also a bottom sub-frame boundary of the bottom sub-frame, a left picture boundary includes a left sub-frame boundary of the top sub-frame and a left sub-frame boundary of the bottom sub-frame, and a right picture boundary includes a right sub-frame boundary of the top sub-frame and a right sub-frame boundary of the bottom sub-frame. In accordance with the spherical neighbor based adaptive loop filtering method, padding pixels are appended to all sub-frame boundaries of the top sub-frame and the bottom sub-frame, where the padding pixels include spherical neighboring pixels which are not set by directly repeating boundary pixels located on sub-frame boundaries of the top sub-frame and the bottom sub-frame.

As shown in FIG. 8, one working buffer 140/150 may act as a sub-frame buffer used to store the top sub-frame (which includes square projection faces “Right”, “Front”, and “Left”) and associated padding pixels (which are included in a plurality padding areas R1-R8 and C1-C4 extended from sub-frame boundaries of the top sub-frame); and another working buffer 140/150 may act as a sub-frame used to store the bottom sub-frame (which includes square projection faces “Top”, “Back”, and “Bottom”) and associated padding pixels (which are included in a plurality padding areas R9-R16 and C5-C8 extended from sub-frame boundaries of the bottom sub-frame).

In one exemplary design, spherical neighboring pixels can be found by using a face based scheme. Hence, a spherical neighboring pixel is directly set by a copy of a pixel in a projection face packed in a reconstructed frame. In a case where there are multiple projection faces packed in a projection layout, a spherical neighboring pixel is found in another projection face different from one projection face at which a current pixel to be adaptive loop filtered is located. In another case where there is only a single projection face packed in a projection layout, a spherical neighboring pixel is found in the same projection face at which a current pixel to be adaptive loop filtered is located.

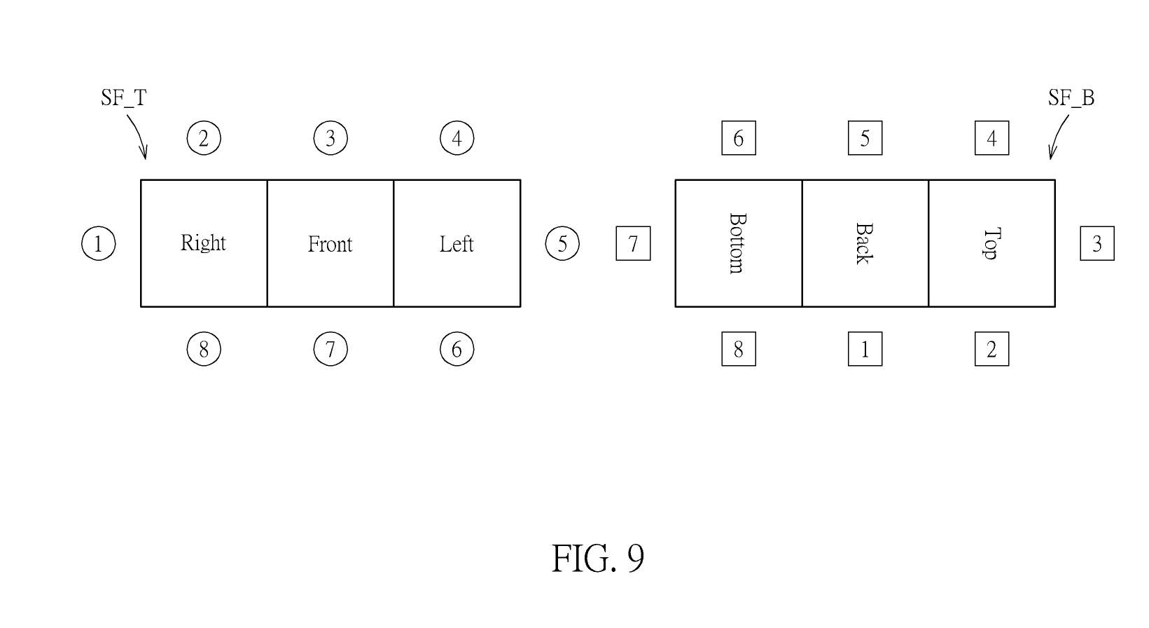

FIG. 9 is a diagram illustrating image content continuity relations among square projection faces packed in the compact CMP layout 204. The top sub-frame SF T of the reconstructed projection-based frame R/R′ includes square projection faces “Right”, “Front”, and “Left”. The bottom sub-frame SF B of the reconstructed projection-based frame R/R′ includes square projection faces “Top”, “Back”, and “Bottom”. There is image content continuity between face boundaries marked by the same reference numeral. Taking the square projection face “Top” in the bottom sub-frame SF B for example, a real adjacent projection face in the top sub-frame SF T that is adjacent to the face boundary marked by “4” is the square projection face “Left”, a real adjacent projection face in the top sub-frame SF T that is adjacent to the face boundary marked by “3” is the square projection face “Front”, and a real adjacent projection face in the top sub-frame SF T that is adjacent to the face boundary marked by “2” is the square projection face “Right”. Regarding an adaptive loop filtering process of pixels that are included in the square projection face “Top” and are near the face boundary marked by “4”, spherical neighboring pixels (which are padding pixels required by the adaptive loop filtering process) can be found from the square projection face “Left” by copying pixels that are included in the square projection face “Left” and are near the face boundary marked by “4”. Regarding an adaptive loop filtering process of pixels that are included in the square projection face “Top” and are near the face boundary marked by “3”, spherical neighboring pixels (which are padding pixels required by the adaptive loop filtering process) can be found from the square projection face “Front” by copying pixels that are included in the square projection face “Front” and are near the face boundary marked by “3”. Regarding an adaptive loop filtering process of pixels that are included in the square projection face “Top” and are near the face boundary marked by “2”, spherical neighboring pixels (which are padding pixels required by the adaptive loop filtering process) can be found from the square projection face “Right” by copying pixels that are included in the square projection face “Right” and are near the face boundary marked by “2”.

Please refer to FIG. 8 in conjunction with FIG. 9. The padding area R1 extended from the left face boundary of the square projection face “Right” is obtained by copying an image area S1 of the square projection face “Back” and then properly rotating a copied image area, where a region on the sphere 200 to which the padding area R1 corresponds is adjacent to a region on the sphere 200 from which the square projection face “Right” is obtained. The padding area R2 extended from the top face boundary of the square projection face “Right” is obtained by copying an image area S2 of the square projection face “Top”, where a region on the sphere 200 to which the padding area R2 corresponds is adjacent to a region on the sphere 200 from which the square projection face “Right” is obtained. The padding area R3 extended from the top face boundary of the square projection face “Front” is obtained by copying an image area S3 of the square projection face “Top” and then properly rotating a copied image area, where a region on the sphere 200 to which the padding area R3 corresponds is adjacent to a region on the sphere 200 from which the square projection face “Front” is obtained. The padding area R4 extended from the top face boundary of the square projection face “Left” is obtained by copying an image area S4 of the square projection face “Top” and then properly rotating a copied image area, where a region on the sphere 200 to which the padding area R4 corresponds is adjacent to a region on the sphere 200 from which the square projection face “Left” is obtained.

The padding area R5 extended from the right face boundary of the square projection face “Left” is obtained by copying an image area S5 of the square projection face “Back” and then properly rotating a copied image area, where a region on the sphere 200 to which the padding area R5 corresponds is adjacent to a region on the sphere 200 from which the square projection face “Left” is obtained. The padding area R6 extended from the bottom face boundary of the square projection face “Left” is obtained by copying an image area S6 of the square projection face “Bottom”, where a region on the sphere 200 to which the padding area R6 corresponds is adjacent to a region on the sphere 200 from which the square projection face “Left” is obtained. The padding area R7 extended from the bottom face boundary of the square projection face “Front” is obtained by copying an image area S7 of the square projection face “Bottom” and then properly rotating a copied image area, where a region on the sphere 200 to which the padding area R7 corresponds is adjacent to a region on the sphere 200 from which the square projection face “Front” is obtained. The padding area R8 extended from the bottom face boundary of the square projection face “Right” is obtained by copying an image area S8 of the square projection face “Bottom” and then properly rotating a copied image area, where a region on the sphere 200 to which the padding area R8 corresponds is adjacent to a region on the sphere 200 from which the square projection face “Right” is obtained.

The padding area R9 extended from the left face boundary of the square projection face “Bottom” is obtained by copying an image area S9 of the square projection face “Front” and then properly rotating a copied image area, where a region on the sphere 200 to which the padding area R9 corresponds is adjacent to a region on the sphere 200 from which the square projection face “Bottom” is obtained. The padding area R10 extended from the bottom face boundary of the square projection face “Bottom” is obtained by copying an image area S10 of the square projection face “Right” and then properly rotating a copied image area, where a region on the sphere 200 to which the padding area R10 corresponds is adjacent to a region on the sphere 200 from which the square projection face “Bottom” is obtained. The padding area R11 extended from the bottom face boundary of the square projection face “Back” is obtained by copying an image area S11 of the square projection face “Right” and then properly rotating a copied image area, where a region on the sphere 200 to which the padding area R11 corresponds is adjacent to a region on the sphere 200 from which the square projection face “Back” is obtained. The padding area R12 extended from the bottom face boundary of the square projection face “Top” is obtained by copying an image area S12 of the square projection face “Right”, where a region on the sphere 200 to which the padding area R12 corresponds is adjacent to a region on the sphere 200 from which the square projection face “Top” is obtained.

The padding area R13 extended from the right face boundary of the square projection face “Top” is obtained by copying an image area S13 of the square projection face “Front” and then properly rotating a copied image area, where a region on the sphere 200 to which the padding area R13 corresponds is adjacent to a region on the sphere 200 from which the square projection face “Top” is obtained. The padding area R14 extended from the top face boundary of the square projection face “Top” is obtained by copying an image area S14 of the square projection face “Left, and then properly rotating a copied image area, where a region on the sphere 200 to which the padding area R14 corresponds is adjacent to a region on the sphere 200 from which the square projection face “Top” is obtained. The padding area R15 extended from the top face boundary of the square projection face “Back” is obtained by copying an image area S15 of the square projection face “Left” and then properly rotating a copied image area, where a region on the sphere 200 to which the padding area R15 corresponds is adjacent to a region on the sphere 200 from which the square projection face “Back” is obtained. The padding area R16 extended from the top face boundary of the square projection face “Bottom” is obtained by copying an image area S16 of the square projection face “Left”, where a region on the sphere 200 to which the padding area R16 corresponds is adjacent to a region on the sphere 200 from which the square projection face “Bottom” is obtained.

Regarding the padding areas C1-C4, they may be generated by repeating four corner pixels of the top sub-frame. Specifically, padding pixels in the padding area C1 are generated by repeating a leftmost pixel at a topmost row of the square projection face “Right”, padding pixels in the padding area C2 are generated by repeating a rightmost pixel at a topmost row of the square projection face “Left”, padding pixels in the padding area C3 are generated by repeating a leftmost pixel at a bottommost row of the square projection face “Right”, and padding pixels in the padding area C4 are generated by repeating a rightmost pixel at a bottommost row of the square projection face “Left”.

Regarding the padding areas C5-C8, they may be generated by repeating four corner pixels of the bottom sub-frame. Specifically, padding pixels in the padding area C5 are generated by repeating a leftmost pixel at a topmost row of the square projection face “Bottom”, padding pixels in the padding area C6 are generated by repeating a rightmost pixel at a topmost row of the square projection face “Top”, padding pixels in the padding area C7 are generated by repeating a leftmost pixel at a bottommost row of the square projection face “Bottom”, and padding pixels in the padding area C8 are generated by repeating a rightmost pixel at a bottommost row of the square projection face “Top”.

In another exemplary design, spherical neighboring pixels can be found by using a geometry based scheme. In accordance with the geometry based scheme, spherical neighboring pixel(s) included in a padding area can be found by 3D projection. In a case where there are multiple projection faces packed in a projection layout, the geometry based scheme applies geometry mapping to projected pixel (s) on an extended area of a projection face to find point(s) on another projection face, and derives spherical neighboring pixel(s) from the point(s). In another case where there is only a single projection face packed in a projection layout, the geometry based scheme applies geometry mapping to projected pixel(s) on an extended area of a projection face to find point(s) on the same projection face, and derives spherical neighboring pixel(s) from the point(s).

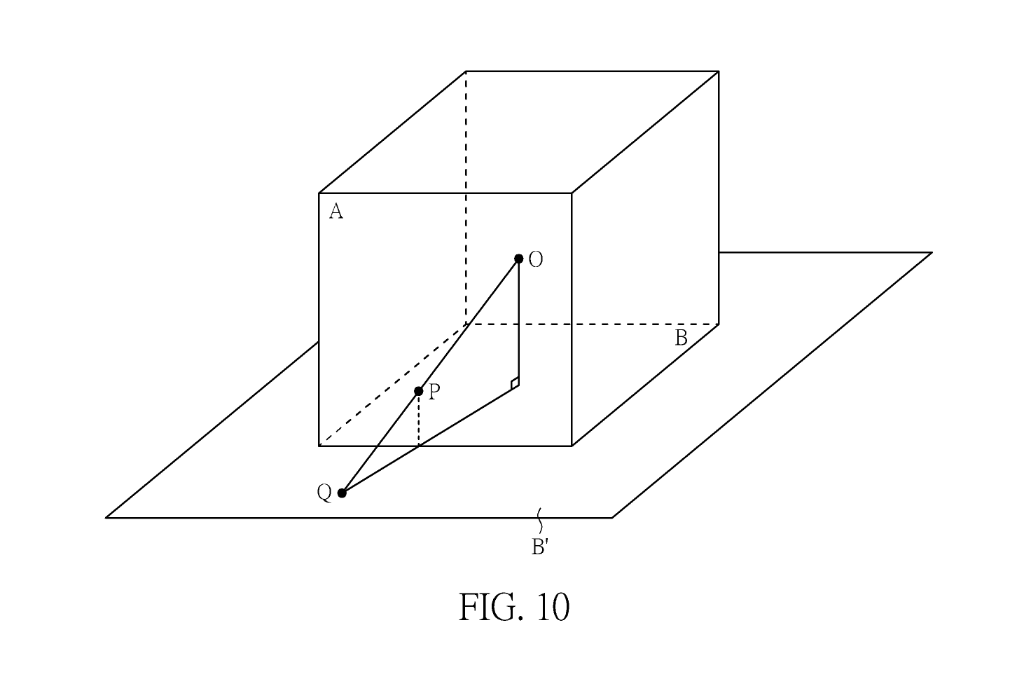

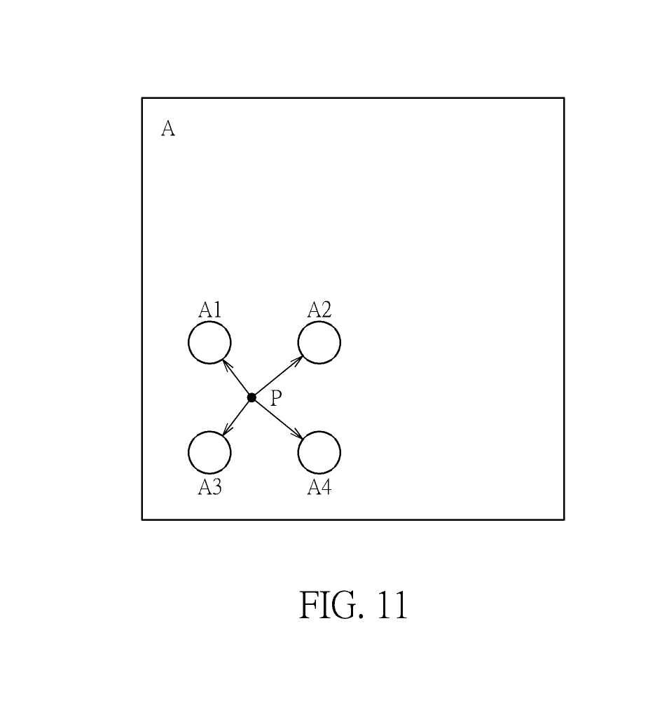

FIG. 10 is a diagram illustrating a spherical neighboring pixel found by a geometry based scheme according to an embodiment of the present invention. A padding area is needed to be generated for a face B (e.g., bottom face of cube 201). To determine a pixel value of a projected pixel (which is a spherical neighboring pixel) Q on an extended area B′ of the face B, a point P on a face A (e.g., front face of cube 201) is found. As shown in FIG. 10, the point P is an intersection point of the face A and a straight line O̅Q̅ (which is from a projection center O (e.g., a center of the sphere 200) to the projected pixel Q). The pixel value of the point P is used for setting the pixel value of the projected pixel Q. In a case where the point P is an integer-position pixel of the face A, the pixel value of the projected pixel Q is directly set by the pixel value of the integer-position pixel. In another case where the point P is not an integer-position pixel of the face A, interpolation is performed to determine the pixel value of the point P. FIG. 11 is a diagram illustrating an example of generating an interpolated pixel value for the point P according to an embodiment of the present invention. In this example, pixel values of four nearest integer-position pixels A1, A2, A3, and A4 in the proximity of the point P are blended by interpolation for generating an interpolated pixel value to act as the pixel value of the point P. Hence, the pixel value of the projected pixel Q is set by the interpolated pixel value of the point P. However, this interpolation design is for illustrative purposes only, and is not meant to be a limitation of the present invention. In practice, an interpolation filter used by the geometry based scheme may be a nearest neighbor filter, a bilinear filter, a bicubic filter, or Lanczos filter, depending upon the actual design considerations.

Hence, spherical neighboring pixels in the padding areas R1-R8 and C1-C4 of the top sub-frame can be determined by applying geometry padding to sub-frame boundaries of the top sub-frame, and spherical neighboring pixels in the padding areas R9-R16 and C5-C8 of the bottom sub-frame can be determined by applying geometry padding to sub-frame boundaries of the bottom sub-frame.

The width and height of a padding area could depend on the largest processing size used by the adaptive loop filter 134/144 for performing pixel classification methods or filter process on a pixel. For example, the padding width W in the horizontal direction may be defined as floor

$$( \frac{max \{ {W}_{{c}_{1}} , {W}_{{c}_{2}} , … , {W}_{{c}_{N}} , {W}_{f} \}}{2} ) ,$$

and the padding height H in the vertical direction may be defined as floor

$$( \frac{max \{ {H}_{{c}_{1}} , {H}_{{c}_{2}} , … , {H}_{{c}_{N}} , {H}_{f} \}}{2} ) ,$$

where W_{c}_{ᵢ} and H_{c}_{ᵢ} denote the processing width and height in the i-th pixel classification method, respectively, and W_{f} and H_{f} denote the processing width and height in the filter process, respectively.

Since the top sub-frame and padding areas R1-R8 and C1-C4 are stored in one working buffer 140/150 and the bottom sub-frame and padding areas R9-R16 and C5-C8 are stored in another working buffer 140/150, the adaptive loop filter 134/144 can perform three pixel classification methods and the filter process on the working buffers 140/150 (which act as sub-frame buffers) according to the luma component processing flow shown in FIG. 3, and can perform the filter process on the working buffers 140/150 (which act as sub-frame buffers) according to the chroma component processing flow shown in FIG. 7.

For example, when the target pixel P₀ to be classified by the pixel classification filter 402 shown in FIG. 4 is included in one square projection face and is near a sub-frame boundary, one or more of the neighboring pixels R₀-R₁₁ may be obtained from a padding area being one of the padding areas R1-R16 and C1-C8 shown in FIG. 8. In other words, a block (i.e., an ALF processing unit) includes the target pixel P₀ that is near a sub-frame boundary, and at least one of the neighboring pixels R₀-R₁₁ used by the pixel classification filter 402 is a spherical neighboring pixel obtained by the face based scheme or the geometry based scheme.

For another example, when the target 2×2 block 504 to be classified by the pixel classification filter 502 shown in FIG. 5 is included in one square projection face and is near a sub-frame boundary, one or more of the neighboring pixels R₀-R₃₁ may be obtained from a padding area being one of the padding areas R1-R16 and C1-C8 shown in FIG. 8. In other words, a block (i.e., an ALF processing unit) includes the target 2×2 block 504 that is near a sub-frame boundary, and at least one of the neighboring pixels R₀-R₃₁ used by the pixel classification filter 502 is a spherical neighboring pixel obtained by the face based scheme or the geometry based scheme.

For yet another example, when the target pixel P₀ to be filtered by the filter 602 shown in FIG. 6 is included in one square projection face and is near a sub-frame boundary, one or more of the neighboring pixels R₀-R₁₉ may be obtained from a padding area being one of the padding areas R1-R16 and C1-C8 shown in FIG. 8. In other words, a block (i.e., an ALF processing unit) includes the target pixel P₀ that is near a sub-frame boundary, and at least one of the neighboring pixels R₀-R₁₉ used by the filter 602 is a spherical neighboring pixel obtained by the face based scheme or the geometry based scheme.

To put is simply, adaptive loop filtering processes which are applied to pixels near the picture boundary are more accurate because real neighboring pixels found by the face based scheme or the geometry based scheme are available in the padding area appended to the picture boundary. In addition, adaptive loop filtering processes which are applied to pixels near the image content discontinuity edge between the top sub-frame and the bottom sub-frame would not be affected by the image content discontinuity edge, and can work correctly.

In some embodiments of the present invention, the face based scheme/geometry based scheme finds spherical neighboring pixels (which act as padding pixels outside two sub-frames) and stores the found spherical neighboring pixels into sub-frame buffers (e.g., working buffers 140/150) before the adaptive loop filtering process. There is tradeoff between the buffer size and the computational complexity. To reduce the memory usage of the working buffers 140/150, spherical neighboring pixels can be found by the face based scheme/geometry based scheme in an on-the-fly manner. Hence, during the adaptive loop filtering process, spherical neighboring pixels located outside a currently processed sub-frame can be padded/created dynamically when needed. When the on-the-fly computation of spherical neighboring pixels is implemented in one or both of the adaptive loop filters 134 and 144, the video encoder 116 is allowed to have a single working buffer 140 that acts as a picture buffer for buffering the reconstructed projection-based frame R, and/or the video decoder 122 is allowed to have a single working buffer 150 that acts as a picture buffer for buffering the reconstructed projection-based frame R′. The buffer requirement is relaxed due to the fact that a picture buffer is created in a memory device without extra areas for storing padding pixels. However, the execution time of the spherical neighbor based adaptive loop filtering method may be longer due to the on-the-fly computation which finds needed spherical neighboring pixels on demand.

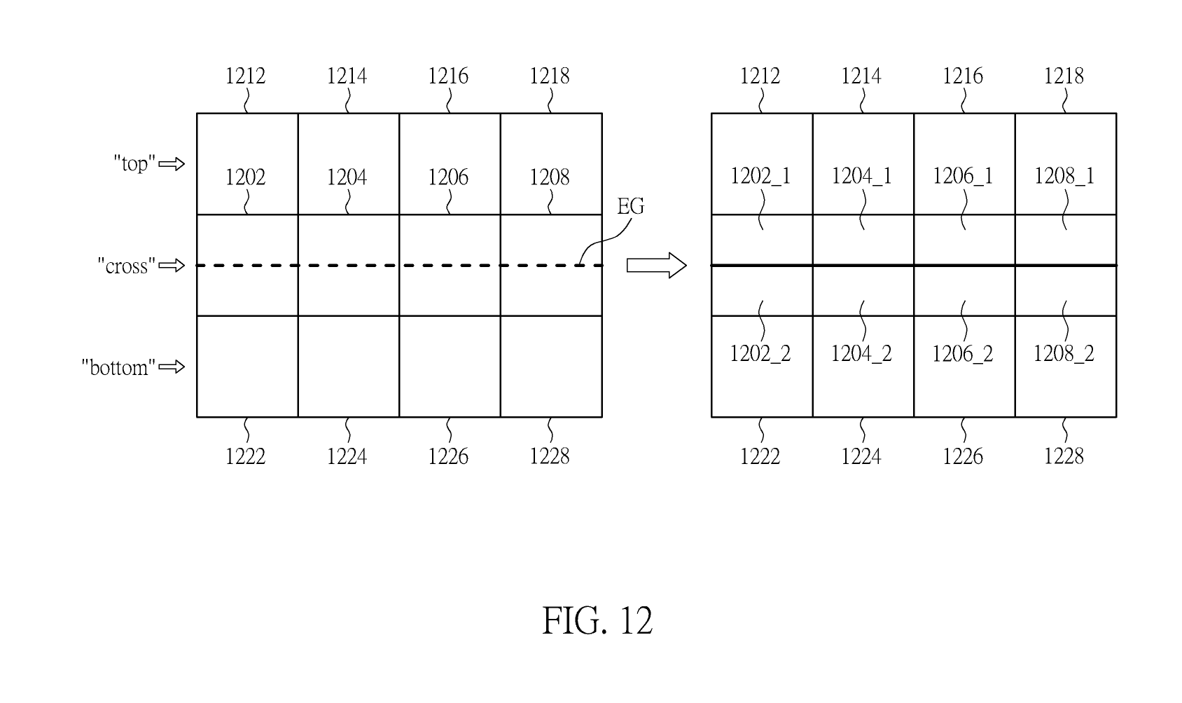

The adaptive loop filter 134/144 may be a block-based adaptive loop filter, and the adaptive loop filtering process may use one block as a basic processing unit. For example, a processing unit may be one coding tree block (CTB) or may be a partition of one CTB. FIG. 12 is a diagram illustrating process units determined and used by the adaptive loop filter 134/144 according to an embodiment of the present invention. Initially, the reconstructed projection-based frame R/R′ is divided into CTBs. If a CTB is located at the top sub-frame, it is labeled as “top”. If a CTB is located at both of the top sub-frame and the bottom sub-frame, it is labeled as “cross”. If a CTB is located at the bottom sub-frame, it is labeled as “bottom”. In this example, each of CTBs 1202, 1204, 1206, and 1208 is labeled as “cross”, each of CTBs 1212, 1214, 1216, and 1218 is labeled as “top”, and each of CTBs 1222, 1224, 1226, 1228 is labeled as “bottom”. If a CTB is labeled as “cross”, it is split into multiple small-sized blocks according to the image content discontinuity edge EG between the top sub-frame and the bottom sub-frame. In this example, the CTB 1202 is split into two small-sized blocks 1201_1 and 1202_2, the CTB 1204 is split into two small-sized blocks 1204_1 and 1204_2, the CTB 1206 is split into two small-sized blocks 1206_1 and 1206_2, and the CTB 1208 is split into two small-sized blocks 1208_1 and 1208_2. As shown in FIG. 12, the processing units actually used by the adaptive loop filter 134/144 include large-sized blocks (i.e., CTBs) 1212, 1214, 1216, 1218, 1222, 1224, 1226, 1228, and small-sized blocks 1202_1, 1202_2, 1204_1, 1204_2, 1206_1, 1206_2, 1208_1, 1208_2. The processing units are determined from the reconstructed projection-based frame R/R′ with no padding, and may be mapped to sub-frames with padding that are stored in sub-frame buffers. Since none of the processing units is across the image content discontinuity edge EG, the pixel classification and filter process would not be affected by the image content discontinuity edge EG when adaptive loop filtering is applied to processing units near the image content discontinuity edge EG.

In above embodiments, padding is appended to sub-frame boundaries of each sub-frame included in the reconstructed projection-based frame R/R′. However, this is for illustrative purposes only, and is not meant to be a limitation of the present invention. Alternatively, padding may be appended to face boundaries of each projection face included in the reconstructed projection-based frame R/R′.

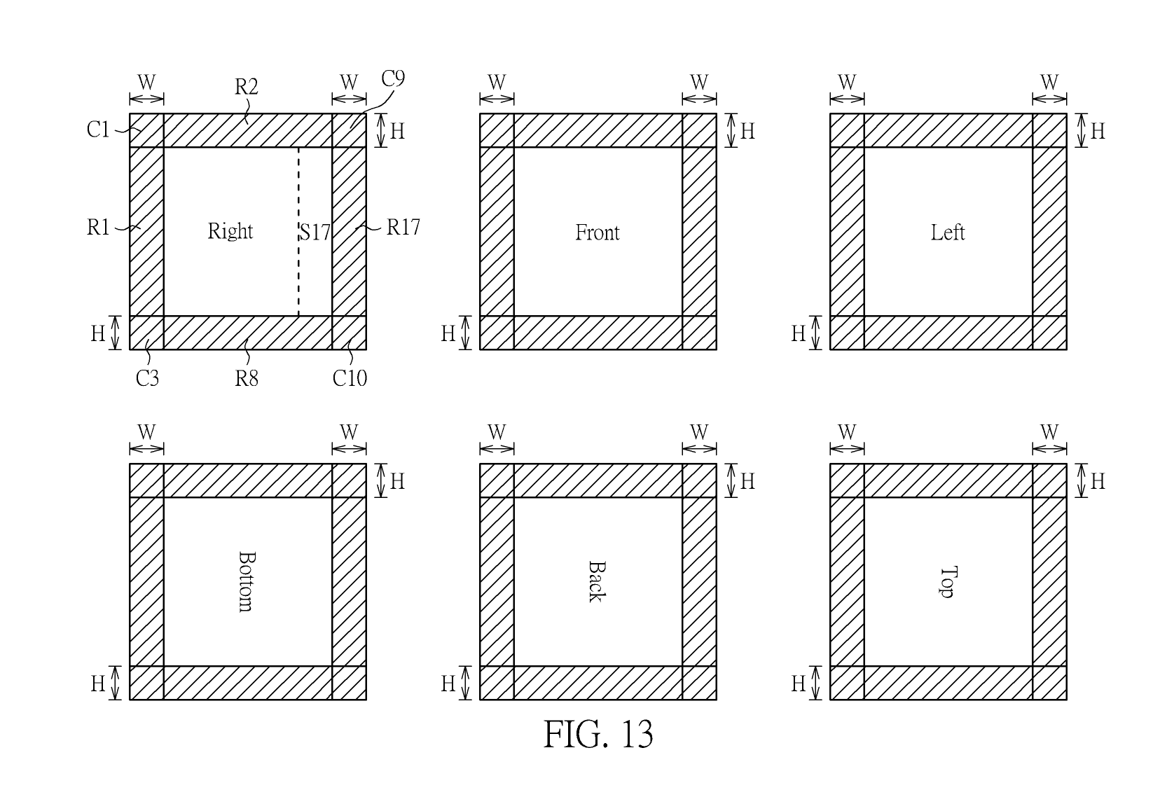

FIG. 13 is a diagram illustrating another arrangement of reconstructed frame data and padding pixel data stored in working buffers 140/150 of adaptive loop filter 134/144 according to an embodiment of the present invention. Suppose that the reconstructed projection-based frame R/R′ employs the compact CMP layout 204. Hence, padding added to face boundaries of square projection faces “Right”, “Front”, “Left”, “Top”, “Back”, and “Bottom” includes padding added to sub-frame boundaries of the top sub-frame and bottom sub-frame and padding added to continuous face boundaries between adjacent square projection faces that are continuous projection face. Taking the square projection face “Right” for example, padding areas R1, R2, R8, R17 may be generated by the face based scheme or the geometry based scheme, and padding areas C1, C3, C9, C10 may be generated by the geometry based scheme or generated by repeating corner pixels. It should be noted that there is image content continuity between the right face boundary of the square projection face “Right” and the left face boundary of the square projection face “Front”. In other words, an image area S17 in the square projection face “Right” and a neighboring image area in the square projection face “Front” are on opposite sides of an image content continuity edge between the square projection faces “Right” and “Front”. The padding area R17 may be obtained by applying geometry padding to the right face boundary of the square projection face “Right”, where the padding area R17 may be different from the neighboring image area in the square projection face “Front”. Alternatively, the padding area R17 may be obtained by copying the neighboring image area in the square projection face “Front”. No matter which scheme is employed, a region on the sphere 200 to which the padding area R17 corresponds is adjacent to a region on the sphere 200 from which the square projection face “Right” is obtained. In other words, the padding area R17 is a spherical neighbor of the image area S17 in the square projection face “Right”. Further, the padding width W in the horizontal direction may be defined as floor

$$( \frac{max \{ {W}_{{c}_{1}} , {W}_{{c}_{2}} , … , {W}_{{c}_{N}} , {W}_{f} \}}{2} ) ,$$

and the padding height H in the vertical direction may be defined as floor

$$( \frac{max \{ {H}_{{c}_{1}} , {H}_{{c}_{2}} , … , {H}_{{c}_{N}} , {H}_{f} \}}{2} ) .$$

The video encoder 116 may be configured to have six working buffers 140 that act as projection face buffers. In addition, the video decoder 122 may be configured to have six working buffers 140/150 that act as projection face buffers. A first projection face buffer is used to store the square projection face “Right” and associated padding areas extended from face boundaries. A second projection face buffer is used to store the square projection face “Front” and associated padding areas extended from face boundaries. A third projection face buffer is used to store the square projection face “Left” and associated padding areas extended from face boundaries. A fourth projection face buffer is used to store the square projection face “Top” and associated padding areas extended from face boundaries. A fifth projection face buffer is used to store the square projection face “Back” and associated padding areas extended from face boundaries. A sixth projection face buffer is used to store the square projection face “Bottom” and associated padding areas extended from face boundaries.

The adaptive loop filter 134/144 performs adaptive loop filtering processes on data stored in the projection face buffers. To reduce the memory usage of the working buffers 140/150, spherical neighboring pixels can be found by the face based scheme/geometry based scheme in an on-the-fly manner. Hence, during the adaptive loop filtering process, spherical neighboring pixels located outside a currently processed projection face can be padded/created dynamically when needed. When the on-the-fly computation of spherical neighboring pixels is implemented in one or both of the adaptive loop filters 134 and 144, the video encoder 116 is allowed to have a single working buffer 140 that acts as a picture buffer for buffering the reconstructed projection-based frame R, and/or the video decoder 122 is allowed to have a single working buffer 150 that acts as a picture buffer for buffering the reconstructed projection-based frame R′.

The adaptive loop filter 134/144 may be a block-based adaptive loop filter, and the adaptive loop filtering process may use one block as a basic processing unit. For example, a processing unit may be one coding tree block (CTB) or may be a partition of one CTB. Initially, the reconstructed projection-based frame R/R′ is divided into CTBs. If a CTB is across an image content discontinuity edge between the top sub-frame and the bottom sub-frame, it is split into small-sized blocks. In addition, if a CTB is across an image content continuity edge between adjacent square projection faces that are continuous projection faces, it is split into small-sized blocks. Assuming that the edge EG shown in FIG. 12 is an image content continuity edge, each of the CTBs 1202, 1204, 1206, and 1208 is split into two small-sized blocks. Since none of the processing units is across the image content discontinuity edge between sub-frames and across the image content continuity edge between adjacent projection faces, the pixel classification and filter process would not be affected by the image content discontinuity edge when adaptive loop filtering is applied to processing units near the image content discontinuity edge, and the pixel classification and filter process would not be affected by the image content continuity edge when adaptive loop filtering is applied to processing units near the image content continuity edge.

In above embodiments, the proposed spherical neighbor based adaptive loop filtering method is employed by the adaptive loop filter 134/144 to control adaptive loop filtering of blocks near sub-frame boundaries (or face boundaries) of the reconstructed projection-based frame R/R′ with projection faces packed in a cube-based projection layout (e.g., compact CMP layout 204). However, this is for illustrative purposes only, and is not meant to be a limitation of the present invention. Alternatively, the proposed spherical neighbor based adaptive loop filtering method may be employed by the adaptive loop filter 134/144 to control adaptive loop filtering of blocks near sub-frame boundaries (or face boundaries) of the reconstructed projection-based frame R/R′ with projection faces packed in a different projection layout. For example, the 360 VR projection layout L_VR may be an equirectangular projection (ERP) layout, a padded equirectangular projection (PERP) layout, an octahedron projection layout, an icosahedron projection layout, a truncated square pyramid (TSP) layout, a segmented sphere projection (SSP) layout, or a rotated sphere projection layout.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An adaptive loop filtering (ALF) method for a reconstructed projection-based frame that comprises a plurality of projection faces packed in a projection layout of a 360-degree Virtual Reality (360 VR) projection from which a 360-degree image content of a sphere is mapped onto the projection faces, comprising:
obtaining, by an adaptive loop filter, at least one spherical neighboring pixel in a padding area that acts as an extension of one face boundary of a first projection face, wherein the projection faces packed in the reconstructed projection-based frame comprise the first projection face and a second projection face; in the reconstructed projection-based frame, said one face boundary of the first projection face connects with one face boundary of the second projection face, and there is image content discontinuity between said one face boundary of the first projection face and said one face boundary of the second projection face; and a region on the sphere to which the padding area corresponds is adjacent to a region on the sphere from which the first projection face is obtained; and
applying adaptive loop filtering to a block in the first projection face, wherein said at least one spherical neighboring pixel is involved in said adaptive loop filtering of the block.

2. The ALF method of claim 1, wherein obtaining said at least one spherical neighboring pixel comprises:
directly using at least one pixel selected from one of the projection faces to act as said at least one spherical neighboring pixel.

3. The ALF method of claim 1, wherein obtaining said at least one spherical neighboring pixel comprises:
applying geometry mapping to at least one projected pixel on an extended area of the first projection face to find at least one point on one of the projection faces; and
deriving said at least one spherical neighboring pixel from said at least one point.

4. The ALF method of claim 1, wherein said adaptive loop filtering of the block comprises pixel classification arranged to classify pixels of the block into different groups, and said at least one spherical neighboring pixel is involved in the pixel classification.

5. The ALF method of claim 1, wherein said adaptive loop filtering of the block comprises a filter process arranged to apply filtering to each pixel in the block according to corresponding filter coefficients, and said at least one spherical neighboring pixel is involved in the filter process.

6. The ALF method of claim 1, further comprising:
dividing the reconstructed projection-based frame into a plurality of blocks, wherein the block that undergoes said adaptive loop filtering is one of the blocks, and none of the blocks is across said one face boundary of the first projection face.

7. The ALF method of claim 1, wherein said at least one spherical neighboring pixel is dynamically created during said adaptive loop filtering of the block.

8. The ALF method of claim 1, further comprising:
obtaining at least one spherical neighboring pixel in another padding area that acts as an extension of one picture boundary of the reconstructed projection-based frame; and
applying adaptive loop filtering to another block in one of the projection faces;
wherein one face boundary of said one of the projection faces is a part of said one picture boundary of the reconstructed projection-based frame, a region on the sphere to which said another padding area corresponds is adjacent to a region on the sphere from which said one of the projection faces is obtained, and said at least one spherical neighboring pixel in said another padding area is involved in said adaptive loop filtering of said another block.

9. An adaptive loop filtering (ALF) method for a reconstructed projection-based frame that comprises at least one projection face packed in a projection layout of a 360-degree Virtual Reality (360 VR) projection from which a 360-degree image content of a sphere is mapped onto said at least one projection face, comprising:
obtaining, by an adaptive loop filter, at least one spherical neighboring pixel in a padding area that acts as an extension of one face boundary of a projection face packed in the reconstructed projection-based frame, wherein said one face boundary of the projection face is a part of one picture boundary of the reconstructed projection-based frame, and a region on the sphere to which the padding area corresponds is adjacent to a region on the sphere from which the projection face is obtained; and
applying adaptive loop filtering to a block in the projection face, wherein said at least one spherical neighboring pixel is involved in said adaptive loop filtering of the block.

10. The ALF method of claim 9, wherein obtaining said at least one spherical neighboring pixel comprises:
directly using at least one pixel selected from said at least one projection face to act as said at least one spherical neighboring pixel.

11. The ALF method of claim 9, wherein obtaining said at least one spherical neighboring pixel comprises:
applying geometry mapping to at least one projected pixel on an extended area of the projection face to find at least one point on said at least one projection face; and
deriving said at least one spherical neighboring pixel from said at least one point.

12. The ALF method of claim 9, wherein said adaptive loop filtering of the block comprises pixel classification arranged to classify pixels of the block into different groups, and said at least one spherical neighboring pixel is involved in the pixel classification.

13. The ALF method of claim 9, wherein said adaptive loop filtering of the block comprises a filter process arranged to apply filtering to each pixel in the block according to corresponding filter coefficients, and said at least one spherical neighboring pixel is involved in the filter process.

14. The ALF method of claim 9, wherein said at least one spherical neighboring pixel is dynamically created during said adaptive loop filtering of the block.

15. An adaptive loop filtering (ALF) method for a reconstructed projection-based frame that comprises a plurality of projection faces packed in a projection layout of a 360-degree Virtual Reality (360 VR) projection from which a 360-degree image content of a sphere is mapped onto the projection faces, comprising:
obtaining, by an adaptive loop filter, at least one spherical neighboring pixel in a padding area that acts as an extension of one face boundary of a first projection face, wherein the projection faces packed in the reconstructed projection-based frame comprise the first projection face and a second projection face; in the reconstructed projection-based frame, said one face boundary of the first projection face connects with one face boundary of the second projection face, and there is image content continuity between said one face boundary of the first projection face and said one face boundary of the second projection face; and a region on the sphere to which the padding area corresponds is adjacent to a region on the sphere from which the first projection face is obtained; and
applying adaptive loop filtering to a block in the first projection face, wherein said at least one spherical neighboring pixel is involved in said adaptive loop filtering of the block.

16. The ALF method of claim 15, wherein obtaining said at least one spherical neighboring pixel comprises:
directly using at least one pixel selected from one of the projection faces to act as said at least one spherical neighboring pixel.

17. The ALF method of claim 15, wherein obtaining said at least one spherical neighboring pixel comprises:
applying geometry mapping to at least one projected pixel on an extended area of the first projection face to find at least one point on one of the projection faces; and
deriving said at least one spherical neighboring pixel from said at least one point.

18. The ALF method of claim 15, wherein said adaptive loop filtering of the block comprises pixel classification arranged to classify pixels of the block into different groups, and said at least one spherical neighboring pixel is involved in the pixel classification.

19. The ALF method of claim 15, wherein said adaptive loop filtering of the block comprises a filter process arranged to apply filtering to each pixel in the block according to corresponding filter coefficients, and said at least one spherical neighboring pixel is involved in the filter process.

20. The ALF method of claim 15, further comprising:
dividing the reconstructed projection-based frame into a plurality of blocks, wherein the block that undergoes said adaptive loop filtering is one of the blocks, and none of the blocks is across said one face boundary of the first projection face.

21. The ALF method of claim 15, wherein said at least one spherical neighboring pixel is dynamically created during said adaptive loop filtering of the block.
